(19) United States
(12) Patent Application Publication
(10) Pub. No.: US 2008/0314896 A1
(43) Pub. Date: Dec. 25, 2008

(54) FOLDABLE PART HOLDER

(75) Inventors: Robert Clark Shellhorn, Yorba Linda, CA (US); Steven Raymond Michaud, West Covina, CA (US)

Correspondence Address: MARTIN S. HIGH, P.O. BOX 217, STILLWATER, OK, 74076, US

(73) Assignee: Chun Yu Works (U.S.A.), Inc., Chino, CA (US)

(21) Appl. No.: 12/144,336

(22) Filed: Jun. 23, 2008

Related U.S. Application Data
(60) Provisional application No. 60/945,590, filed on Jun. 22, 2007.

(51) Int. Cl. B65D 8/14; B31B 1/60

(52) U.S. Cl. 220/6; 493/84

(57) ABSTRACT

A preferred embodiment of the foldable part holder is comprised of a front flap, a bottom flap, a back flap, a top flap, a prong flap, a plurality of folds, a plurality of slots, and a plurality of apertures all of which are formed from a flat sheet of polymeric material. The front flap, the bottom flap, the back flap, the top flap, the prong flap, the plurality of folds, the plurality of slots, and the plurality of apertures are all arranged on the flat sheet such that when the flat sheet is folded along the plurality of folds, the embodiment forms a three-dimensional part holder. The plurality of folds are formed by the polymeric sheet such that when folded the flaps engage each other in the appropriate manner. All of the elements formed onto the flat sheet of polymeric material through any fabrication process common for polymeric materials.

### CROSS-REFERENCE TO RELATED APPLICATIONS

This application claims priority of the provisional application with Ser. No. 60/945,590 titled “FOLDABLE PART HOLDER” filed on Jun. 22, 2007. The entire contents of provisional application 60/945,590 are herein incorporated by reference.

### STATEMENT REGARDING FEDERALLY SPONSORED RESEARCH OR DEVELOPMENT

Not applicable.

### FIELD OF THE EMBODIMENTS

The field of the embodiments described below in general includes fastener part holders that can be secured or attached to the clothing of a user.

### SUMMARY OF THE EMBODIMENTS

A preferred embodiment of the foldable part holder is comprised of a front flap, a bottom flap, a back flap, a top flap, a prong flap, a plurality of folds, a plurality of slots, and a plurality of apertures all of which are formed from a flat sheet of polymeric material. The front flap, the bottom flap, the back flap, the top flap, the prong flap, the plurality of folds, the plurality of slots, and the plurality of apertures are all arranged on the flat sheet such that when the flat sheet is folded along the plurality of folds, the embodiment forms a three-dimensional part holder. The plurality of folds are formed by the polymeric sheet such that when folded the flaps engage each other in the appropriate manner. All of the elements formed onto the flat sheet of polymeric material through any fabrication process common for polymeric materials.

### BRIEF DESCRIPTION OF THE DRAWINGS

FIG. 1a is a view of the foldable holder showing the exterior surfaces of the front flap, the bottom flap, and the back flap; FIG. 1b is a view of the foldable part holder showing the interior surfaces of the front flap, the bottom flap, and the back flap.

FIG. 2a shows the foldable part holder in the extended flat position; FIG. 2b shows a detail of the foldable part holder, specifically how the corner tabs engage in the slots to form the three-dimensional structure.

FIG. 3 shows a detail of the foldable part holder, specifically how the corner tabs engage in the slots to form the three-dimensional structure.

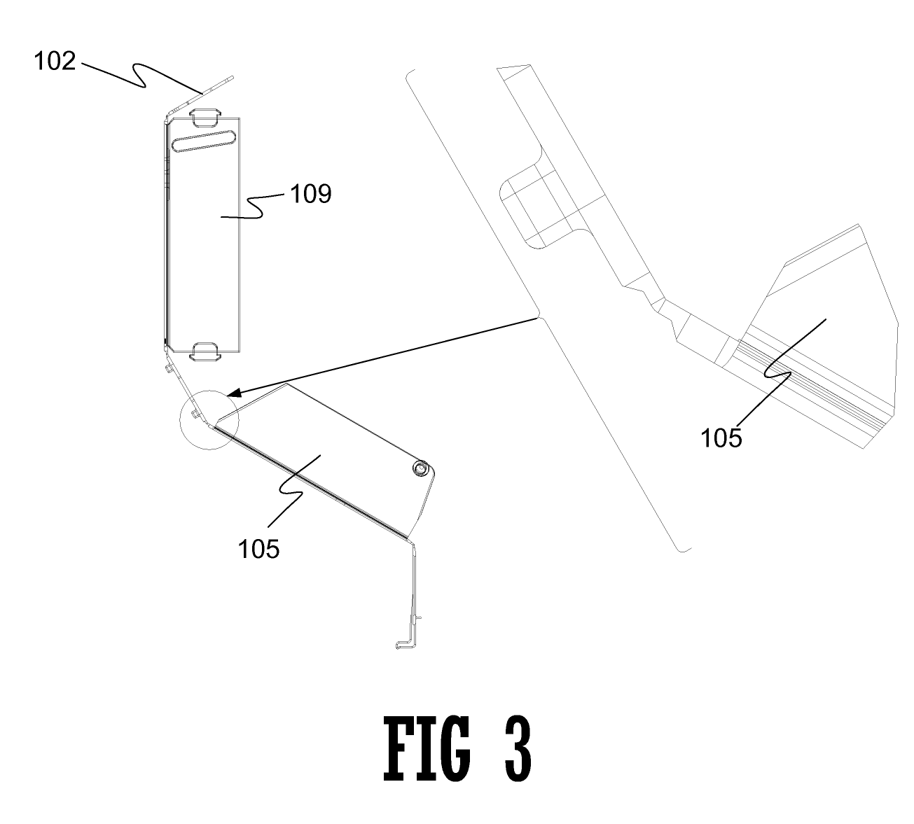

FIG. 4 shows how the foldable part holder is folded into a three-dimensional embodiment of the foldable part holder.

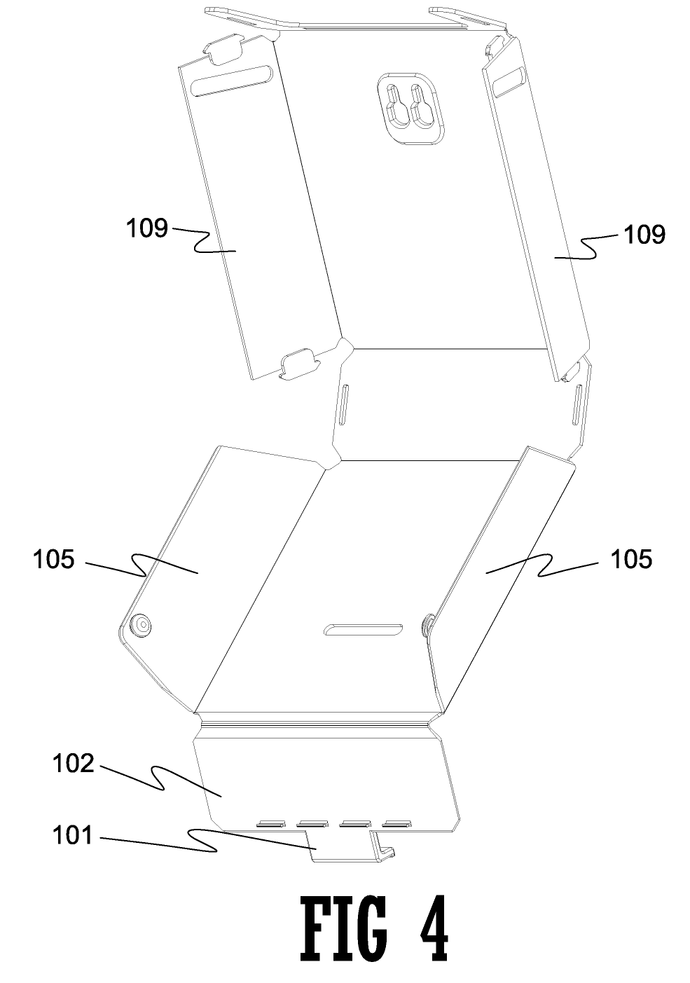

FIG. 5a is a front view of the belt clip for the foldable part holder; FIG. 5b is a top view of the belt clip for the foldable part holder; FIG. 5c is a side view of the belt clip for the foldable part holder; FIG. 5d is a perspective view of the belt clip for the foldable part holder.

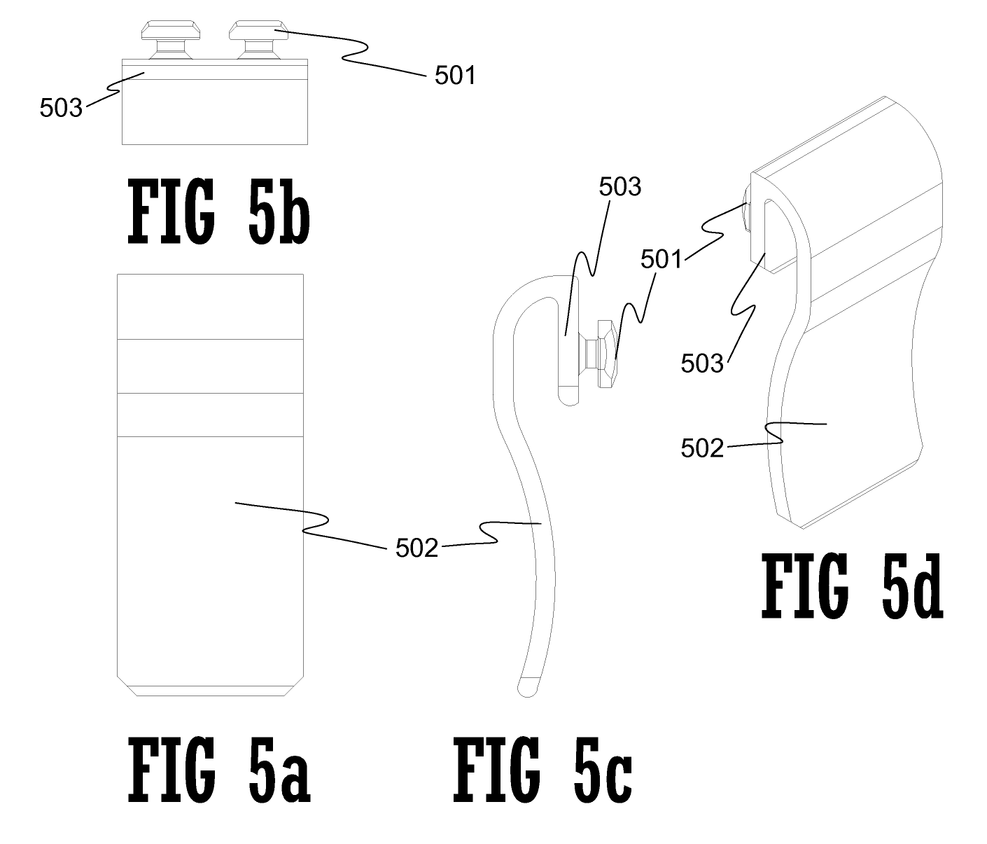

FIG. 6a is a top view of the foldable part holder in the assembled embodiment; FIG. 6b is a front view of the foldable part holder in the assembled embodiment; FIG. 6c is a bottom view of the foldable part holder in the assembled embodiment; FIG. 6d is a side view of the foldable part holder in the assembled embodiment; and FIG. 6e is a perspective view of the foldable part holder in the assembled embodiment.

FIG. 7a is a top view of the foldable part holder in the assembled embodiment; FIG. 7b is a front view of the foldable part holder and in the assembled embodiment; FIG. 7c is a bottom view of the foldable part holder and in the assembled embodiment; and FIG. 7d is a side of the foldable part holder in the assembled embodiment.

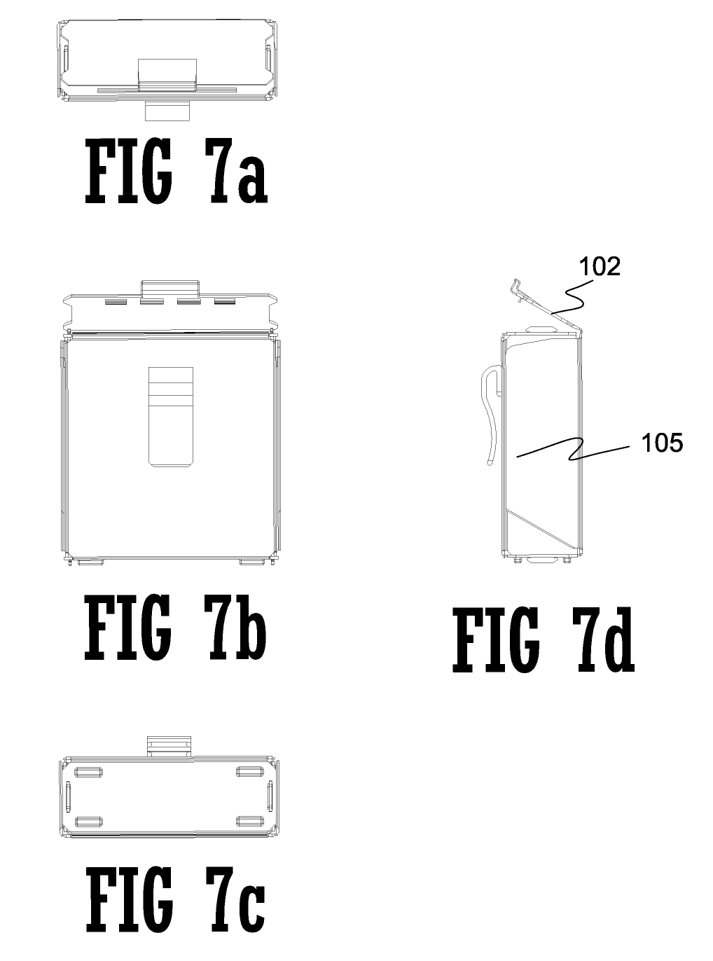

FIG. 8a is a perspective view of the foldable part holder in the assembled embodiment; FIG. 8b is another perspective view of the foldable part holder in the assembled embodiment.

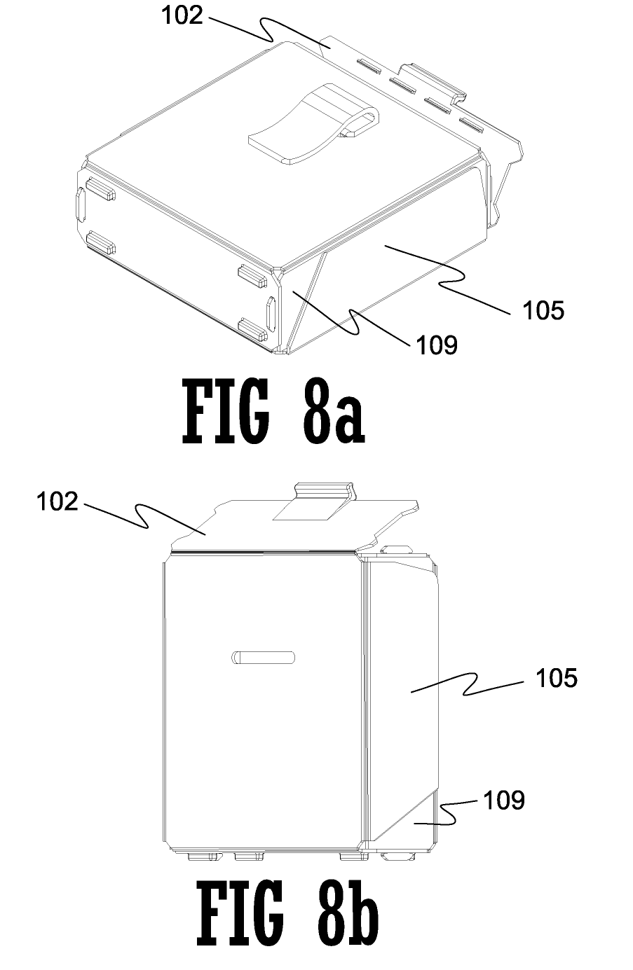

FIG. 9a is a top view of the foldable part holder in the assembled embodiment with the top flap open; FIG. 9b is a front view of the foldable part holder in the assembled embodiment with the top flap partially open; FIG. 9c is a bottom view of the foldable part holder in the assembled embodiment with the top flap open; FIG. 9d is a side view of the foldable part holder in the assembled embodiment with the top open and the expandable flap in the open position; FIG. 9e is a perspective view of the foldable part holder in the assembled embodiment with the top open showing a detail of the top catch.

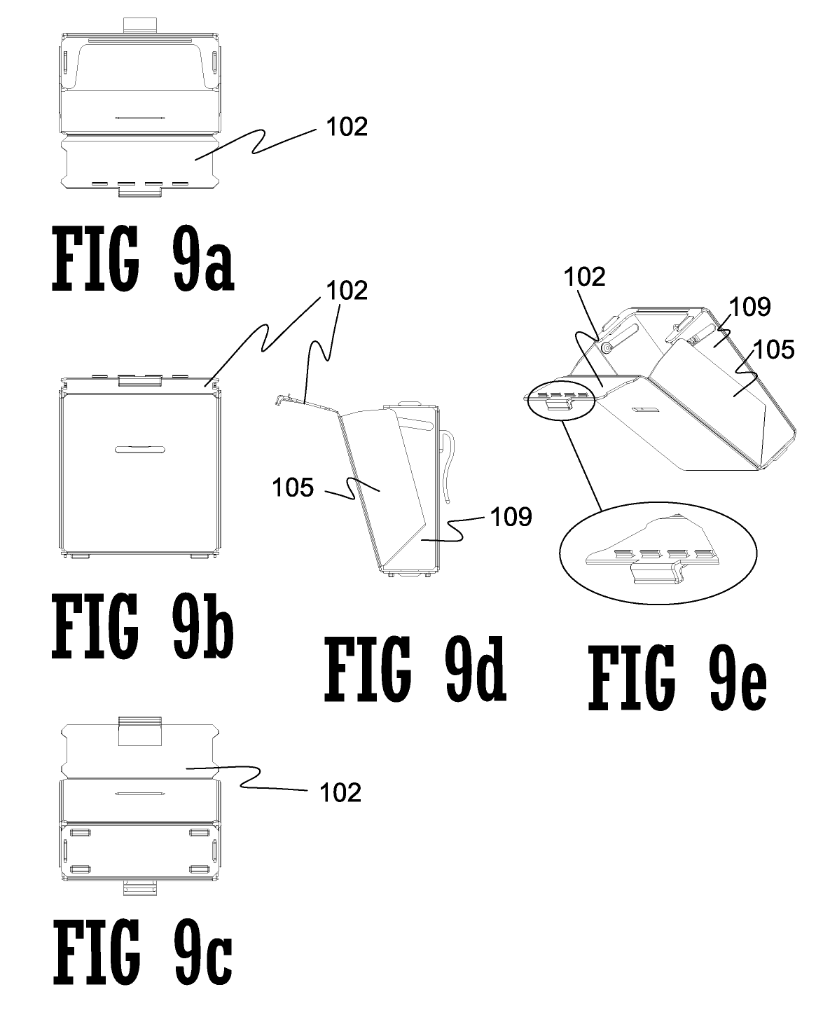

FIG. 10a is a top view of the of the foldable part holder in the assembled embodiment with the top completely open; FIG. 10b is a front view of the foldable part holder in the assembled embodiment with the top completely open; FIG. 10c is a bottom view of the foldable part holder in the assembled embodiment with the top completely open; FIG. 10d is a side view of the of the foldable part holder in the assembled embodiment with the top completely open and showing the front sleeve in the expanded position.

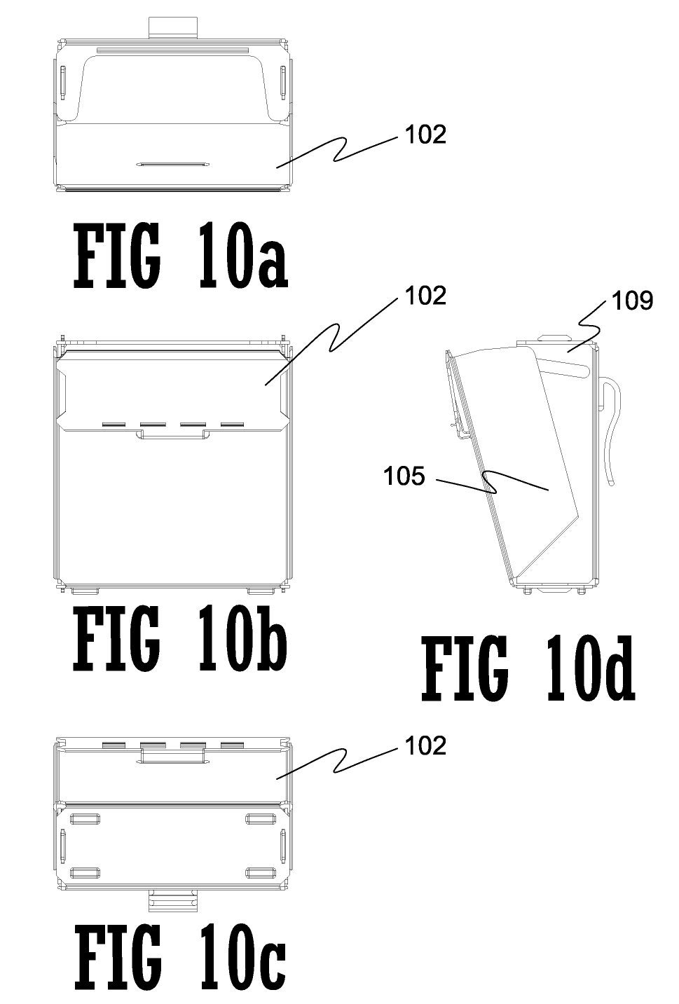

FIG. 11a is a perspective view of the of the foldable part holder in the assembled embodiment showing a detail of the slide guide in its aperture; FIG. 11b is a perspective view of the foldable part holder in the assembled embodiment.

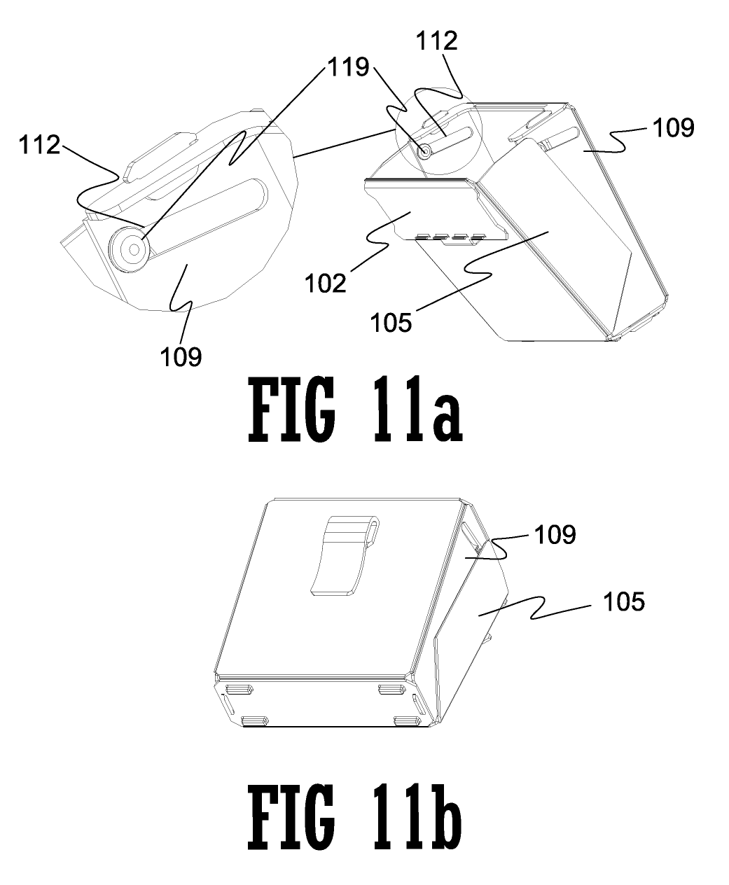

### DETAILED DESCRIPTION

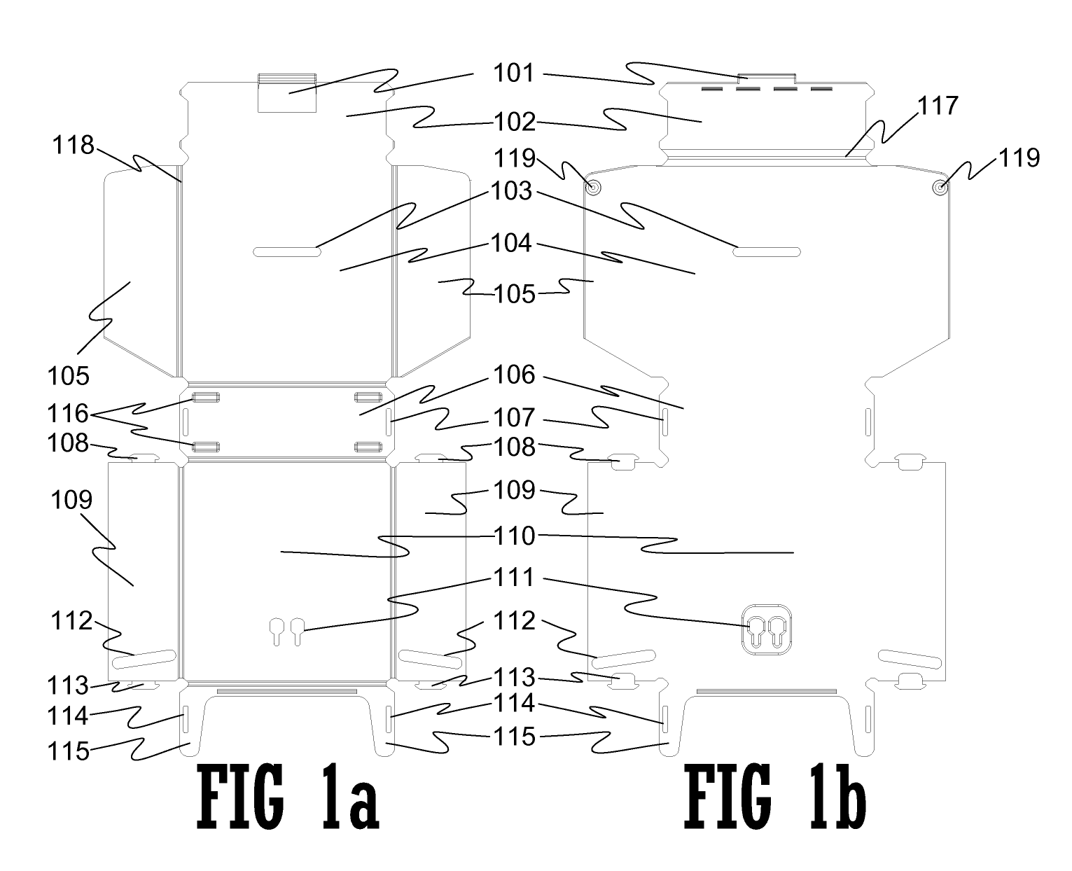

Referring to FIGS. 1a and 1b, a preferred embodiment the foldable part holder is comprised of a front flap 104, a bottom flap 106, a back flap 110, a top flap 102, a prong flap 115, a plurality of folds, a plurality of slots, and a plurality of apertures all of which are formed from a polymeric sheet. The polymeric sheet is formed from a flat sheet of solid polymeric material. The front flap 104, the bottom flap 106, the back flap 110, the top flap 102, the prong flap 115, the plurality of folds, the plurality of slots, and the plurality of apertures are all arranged on the polymeric sheet such that when the polymeric sheet is folded along the plurality of folds, the embodiment forms a three-dimensional part holder. The plurality of folds are formed by the polymeric sheet such that when folded the flaps engage each other in the appropriate manner. The three-dimensional part holder can hold a variety of small objects and parts such as, but not limited to, fasteners such as nails, bolts, nuts, screws, staples, paper clips, machine parts, assembly parts and other small items that need to be keep in proximity to the user and readily accessible.

All of the elements of the embodiments are formed onto the polymeric sheet through any polymeric material fabrication process that can produce the structural elements described herein including, but not limited to a molding process or a stamping process. When it is stated that two components are connected via a fold, this means that a fold is formed in the polymeric material between the two components. The solid polymeric material can be any stiff, but slightly flexible, polymeric material including, but not limited to, polyethylene, polypropylene, polystyrene, poly(vinyl chloride) and any copolymers of polyethylene, polypropylene, polystyrene, poly(vinyl chloride).

The top flap 102 is an essentially rectangular sheet of polymeric material. The top flap forms the top and lid of the foldable part holder in the assembled embodiment. The top flap 102 further comprises a top flap stop 101 which is used to secure the top of the embodiment when the embodiment is assembled in the folded configuration. The top flap stop 101 is integrally molded onto the top flap 102. The top flap 102 is joined to the front flap 104 via a top flap fold 117 as shown in FIG. 1a.

In one embodiment of the part holder, the front flap 104 is an essentially square sheet of polymeric material. The square sheet forms the front surface of the part holder in the assembled embodiment. The front flap 104 is further comprised of a plurality of slide buttons 119 integrally formed onto the interior side of the front flap 104. In another embodiment of the foldable part holder, the plurality of side buttons is comprised of two slide buttons 119. The slide buttons 119 engage with the slide slots 112 when the embodiment is folded into the assembled three-dimensional part holder.

The front flap 104 is joined to two front side flaps 105 via two back side folds 118. The front flap 104 also forms a front aperture 103. As the embodiment is folded into the three dimensional, assembled embodiment of the part holder, the front side flaps 105 fold inward (out from the plane of the view in FIG. 1a and in to the plane of the view in FIG. 1b) to form the interior sides of the embodiment.

The front flap 104 is joined to the bottom flap 106 via a fold. The bottom flap 106 forms a plurality of feet 116 and a plurality of bottom tab slots 107. The feet 116 allow the foldable part holder to be rested on a surface with stability. The bottom tab slots 107 allow for water or other fluids to drain from the foldable part holder. The bottom tab slots 107 also allow for insertion of the bottom tabs 108 to secure the foldable part holder in the three-dimensional embodiment when assembled.

The bottom flap 106 is joined to the back flap 110 via a fold. The back flap 110 is comprised of a two back side flaps 109 which are joined to the back flap 110 via a fold. The back flap is comprised of two lug holes 111 formed by the back flap 110. The lug holes, as illustrated in FIG. 1a and FIG. 1b, are comprised of essentially keyhole shaped apertures. The lug hole 111 receives the lugs 501 from the belt holder and secures the foldable part holder onto the belt holder via a resistance fit. The lugs 501 are inserted through the larger portion of the lug holes 111 and pushed upward into the smaller portion of the lug holes 111 to form the resistance fit.

In one embodiment, the back side flaps 109 are further comprised of a plurality of tabs. In another embodiment of the foldable part holder, the plurality of tabs is comprised of two bottom tabs 108 and two top tabs 113 as shown in FIG. 1a and FIG. 1b. The bottom tabs 108 engage with the bottom tab slots 107 when the foldable part holder is assembled. The top tabs engage with the prong tab slots 114 when the foldable part holder is assembled.

In an embodiment of the part holder, the back flap is further comprised of a plurality of slide slots which are formed by the back flap. In another embodiment of the foldable part holder, the plurality of slide slots are comprised of two slide slots 112 as shown in FIG. 1a and FIG. 1b. The slide slots 112 engage with the slide buttons 119 when the foldable part holder is assembled and allow the assembled front flap and front side flaps to rotate outward.

The back flap 110 is connected to a prong flap 115 via a fold. The prong flap 115 is comprised of a two prongs formed to a thin connection which is in turn adjacent to the fold as illustrated in FIG. 1a and FIG. 1b. In an embodiment of the foldable part holder, the prong flap is comprised of a plurality of prong tab slots. In another embodiment of the foldable part holder, the plurality of tab slots is comprised of two prong tab slots 114. The two prong tab slots 114 engage with slots 113 to secure the back flap 110 when the foldable part holder is assembled.

In an embodiment of the foldable part holder, the embodiment is assembled by folding at the folds formed into the polymeric material. The two back side flaps 109 are folded towards each other (i.e., referring to FIG. 1a, the two back side flaps 109 are folded into the plane of the view away from the reader; referring to FIG. 1b, the two back side flaps 109 are folded out from the plan of the view toward from the reader). The two front side flaps 105 are folded towards each other in a similar manner. The back flap and front flap are then folded together (i.e., referring to FIG. 1a, the back flap 110 and front flap 104 are folded into the plane of the view away from the reader; referring to FIG. 1b, the back flap 110 and front flap 104 are folded out from the plan of the view toward from the reader). The back flap 110 and front flap 104 are folded together so that the front side flaps 105 are arranged outside of the back side flaps 109. The bottom tabs 108 are engaged to bottom tab slots 107 to secure the back side flaps. The prong flap 115 is folded onto the opening formed by the bottom flap 104 and top flap 110. The two top tabs 113 are engaged with the prong tab slots 114 to completely secure the bottom flaps 109. The two slide buttons 119 are then engaged into the two slide slots 112 to secure the front flap 104 to the back flap 110. The procedure discussed herein to assemble the foldable part holder is just one of the many methods that can be used in the assembly and this example should not be used to limit the scope of the embodiment.

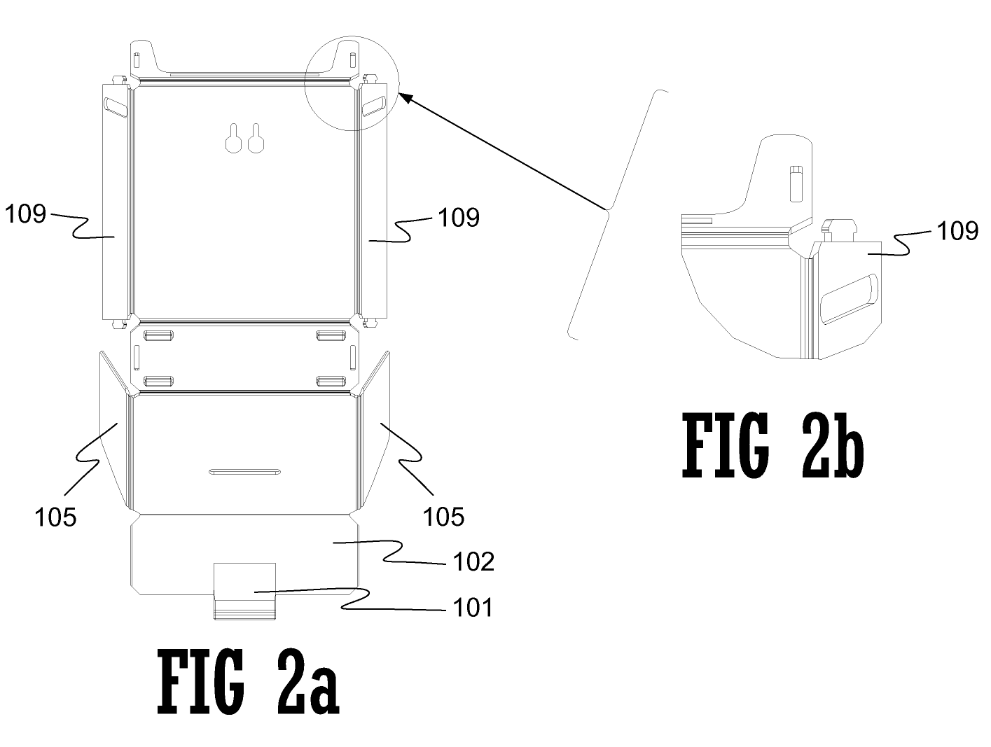

The belt holder illustrated in FIG. 2 is comprised of a belt clip 502, a plurality of lugs 501, and a top surface 503. The lugs 501 are engaged in the lug holes 111 in the back flap 110. The foldable part holder can then be engaged to the belt, pocket, or waistband or any other piece of clothing or object that can accept the belt clip 502 to secure the foldable part holder.

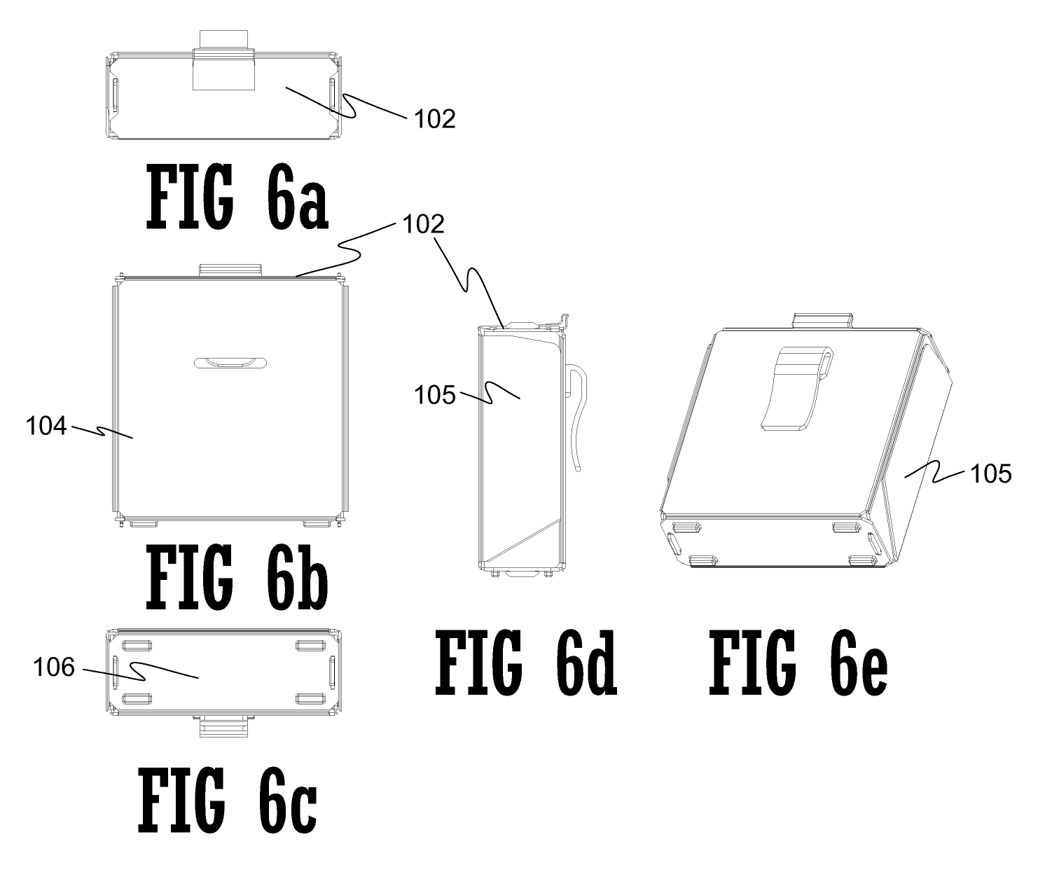

In a best mode of operating the foldable part holder, the foldable part holder can be opened by sliding the front flap 104 outward from the back flap 110. The slide buttons 119 slideably move within the slide slots 112 and the front flap 104 rotatably opens to allow parts to be inserted into the opening and into the foldable part holder. Correspondingly, the front flap 104 and be closed, and the top flap stop 101 secured to the back flap 110 as illustrated in FIG. 6.

In this respect, it is to be understood that the embodiments in this application are not limited to the details of construction and to the arrangements of the components set forth in the description or illustrated in the drawings. The embodiments are capable of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the embodiments described in this application. Additional benefits and advantages of the present embodiments will become apparent in those skilled in the art to which the embodiments relate from the description of the preferred embodiment and the appended claims, taken in conjunction with the accompanying drawings. It is important, therefore, that the claims be regarded as including such equivalent constructions insofar as they do not depart from the spirit and scope of the embodiments described herein.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

What is claimed is:

1) A foldable part holder comprising a polymeric sheet which is comprised of a front flap, a bottom flap, a back flap, a top flap, a prong flap, a plurality of folds, a plurality of slots, and a plurality of apertures wherein the front flap, the bottom flap, the back flap, the top flap, the prong flap, the plurality of folds, the plurality of slots, and the plurality of apertures are all arranged on the polymeric sheet such that when the polymeric sheet is folded along the plurality of folds, the embodiment forms a three-dimensional part holder.

2) The foldable part holder in claim 1 wherein the polymeric sheet is formed from a flat sheet of solid polymeric material.

3) The foldable part holder in claim 1 wherein the plurality of folds are formed by the polymeric sheet such that when folded the flaps engage each other in the appropriate manner to form a three dimensional structure capable of holding small objects.

4) The foldable part holder in claim 1 wherein the front flap, the bottom flap, the back flap, the top flap, the prong flap, a plurality of folds, a plurality of slots, and a plurality of apertures are formed onto the polymeric sheet through a polymeric material fabrication process.

5) The foldable part holder in claim 4 wherein polymeric material fabrication process is either a molding process or a stamping process.

6) The foldable part holder in claim 1 wherein the polymeric sheet is manufactured from polyethylene, polystyrene, or poly(vinyl chloride).

7) The foldable part holder in claim 1 wherein
the top flap is an essentially rectangular sheet of polymeric material,
the top flap forms the top and lid of the foldable part holder in the assembled embodiment,
the top flap further comprises a top flap stop which is used to secure the top of the foldable part holder when the foldable part holder is assembled in the folded configuration, and
the top flap stop is integrally molded onto the top flap, and wherein the top flap is joined to the front flap via a top flap fold.

8) The foldable part holder in claim 1 wherein
the front flap is an essentially square sheet of polymeric material and the square sheet forms the front surface of the foldable part holder in the assembled embodiment.

9) The foldable part holder in claim 1 comprised of a plurality of slide buttons integrally formed onto the interior side of the front flap wherein the slide buttons engage with the slide slots when the foldable part holder is folded into the assembled three-dimensional part holder.

10) The foldable part holder in claim 9 wherein the plurality of side buttons is comprised of two slide buttons and wherein.

11) The foldable part holder in claim 1 wherein
the front flap is joined to two front side flaps via two back side folds; and
the front flap forms a front aperture so that as the invention is folded into the three dimensional, assembled embodiment of the part holder, the front side flaps fold inward to form the interior sides foldable part holder.

12) The foldable part holder in claim 1 wherein
the front flap is joined to the bottom flap via a fold;
the bottom flap forms a plurality of feet and a plurality of bottom tab slots;
the bottom flap is joined to the back flap via a fold;
the back flap is comprised of a two back side flaps which are joined to the back flap via a fold;
the back flap is comprised of two lug holes formed by the back flap 110;
the lug holes are comprised of essentially keyhole shaped apertures;
the lug hole receives the lugs from a belt clip and secures the foldable part holder onto the belt holder via a resistance fit;
the lugs are inserted through the larger portion of the lug holes and pushed upward into the smaller portion of the lug holes 111 to form the resistance fit.

13) The foldable part holder in claim 1 comprised of a belt clip, a plurality of lugs, and a top surface wherein the lugs are engaged in lug holes formed by the back flap.

14) A method of using a foldable part holder comprising a polymeric sheet which is comprised of a front flap, a bottom flap, a back flap, a top flap, a prong flap, a plurality of folds, a plurality of slots, and a plurality of apertures comprised of folding the front flap, the bottom flap, the back flap, the top flap, the prong flap, the plurality of folds, the plurality of slots, and the plurality of apertures such that when the polymeric sheet is folded along the plurality of folds, the embodiment forms a three-dimensional part holder.

15) The method of using a foldable part holder in claim 14 wherein the polymeric sheet is formed from a flat sheet of solid polymeric material.

16) The method of using a foldable part holder in claim 15 wherein the plurality of folds are formed by the polymeric sheet such that when folded the flaps engage each other in the appropriate manner.

17) The method of using a foldable part holder in claim 16 wherein the front flap, the bottom flap, the back flap, the top flap, the prong flap, a plurality of folds, a plurality of slots, and a plurality of apertures are formed onto the polymeric sheet through a polymeric material fabrication process.

18) The method of using a foldable part holder in claim 17 wherein polymeric material fabrication process is either a molding process or a stamping process.

19) The method of using a foldable part holder in claim 18 wherein the polymeric sheet is manufactured from polyethylene, polystyrene, or poly(vinyl chloride).
